(19) United States
(12) Patent Application Publication
(10) Pub. No.: US 2014/0339376 A1
(43) Pub. Date: Nov. 20, 2014

(54) WIRE HARNESS ROUTING DEVICE FOR SLIDING SEAT

(71) Applicant: SUMITOMO WIRING SYSTEMS, LTD., Mie (JP)

(72) Inventors: Shinji KATOU, Mie (JP); Yoshikazu SAKAKIBARA, Mie (JP)

(73) Assignee: SUMITOMO WIRING SYSTEMS, LTD., Mie (JP)

(21) Appl. No.: 14/225,845

(22) Filed: Mar. 26, 2014

(30) Foreign Application Priority Data
May 17, 2013 (JP) 2013-105622

(51) Int. Cl. B60R 16/02

(52) U.S. Cl. CPC B60R 16/0215
USPC 248/49

(57) ABSTRACT

The present invention includes one harness rail having a straight line shape, the harness rail extending in a front-back direction adjacent to a lateral surface of a seat rail of a sliding seat mounted in a vehicle; and an extra length accommodation case linked to a front end of the harness rail. The harness rail includes a first slider sliding portion extending in the front-back direction, while the extra length accommodation case includes a second slider sliding portion linked to a front end of the first slider sliding portion and extending in a straight line front-back direction until reaching a front end arced portion. A slider connected to the sliding seat and displacing in the straight line front-back direction is slidably nested with the first and second slider sliding portions. The wire harness is inserted through the slider and into the harness rail and the extra length accommodation case.

### CROSS-REFERENCE TO RELATED APPLICATIONS

The present application claims priority under 35 U.S.C. §119 of Japanese Application No. 2013-105622, filed on May 17, 2013, the disclosure of which is expressly incorporated by reference herein in its entirety.

### BACKGROUND OF THE INVENTION

1. Field of the Invention

The present invention relates to a wire harness routing device for a sliding seat. Specifically, the present invention seeks to shorten a front-back length of an extra length accommodation case accommodating the extra length of a wire harness routed to a sliding seat mounted in an automobile.

2. Description of Related Art

A variety of electrical components such as a motorized reclining device, a seat heater, and the like are installed in an automobile seat. In order to supply electricity to these components, a power supplying wire harness is routed to the seat from a vehicle body floor. In the case of a sliding seat, the wire harness must follow a sliding motion of the seat and thus the wire harness is routed with extra length. A sliding dimension of the sliding seat in the automobile is typically 240 mm to 300 mm at maximum. However, automobiles have recently been introduced with passenger-side seating, rear seating, or the like that are extended slide seats having a sliding dimension of 400 mm to 1200 mm maximum, enabling a large space to be provided in front of or behind the seat. In such an extended slide seat, the extra length of the wire harness is longer, and thus a rail for the wire harness is required in which the wire harness is linked to front-back displacement of the sliding seat in a manner capable of smoothly entering and exiting an extra length accommodation portion.

A device shown in FIG. 9 is disclosed in Japanese Patent Laid-open Publication No. 2011-121459 by the applicant of the present invention as an example of a wire harness routing device routing a wire harness between the vehicle body floor and the extended slide seat in this kind of vehicle. In the device, a seat wire harness W/H is inserted through a space within a seat rail 101 and the seat rail 101 is used as a wire harness rail, the seat rail 101 having wheels of a sliding seat 100 displaceably mounted thereto. In addition, a wire harness extra length accommodation case 105 is located at a front end of the seat rail 101, and the wire harness W/H makes a U-turn within the extra length accommodation case 105, then is drawn out and connected to a floor harness.

In the device according to Japanese Patent Laid-open Publication No. 2011-121459, the extra length accommodation case 105 linked to the front end of the seat rail 101 extends to the floor forward of the sliding seat 100, where a passenger is likely to step on the seat rail 101. Strength of the extra length accommodation case 105 must therefore be increased and costs rise. Additionally, in many cases preexisting piping, such as air ducts, and components are installed. Thus, space in which to install the extra length accommodation case 105 is limited, and there are restrictions on a shape of the extra length accommodation case 105 so as to not interfere with the air ducts and the like.

In addition, the seat rail is used as the wire harness rail. Therefore, the wire harness rail can be rendered superfluous, but the work of inserting the wire harness into the seat rail is troublesome. Further, lubricating grease filling the seat rail may contaminate the wire harness, displacement of the wire harness within the seat rail may be obstructed by debris that has infiltrated the seat rail, and the like. There is therefore room for improvement.

The present invention was conceived in light of the above concerns. The present invention provides a wire harness rail separate from a seat rail and, in addition, positions an extra length accommodation case so as to link with a front end of the wire harness rail, absorbs an extra length of a wire harness with the wire harness rail and the extra length accommodation case, and restricts a total length of the wire harness rail and the extra length accommodation case such that the extra length accommodation case is not located in an area likely to be stepped on.

### SUMMARY OF THE INVENTION

In order to resolve the above-noted concerns, the present invention provides a wire harness routing device for a sliding seat that includes one harness rail having a straight line shape, the harness rail extending in a front-back direction so as to be adjacent to a lateral surface of a seat rail of a sliding seat mounted in a vehicle; and an extra length accommodation case linked to a front end of the harness rail. The harness rail includes a first slider sliding portion extending in the front-back direction, while the extra length accommodation case includes a second slider sliding portion linked to a front end of the first slider sliding portion and extending in a straight line front-back direction until reaching a front end arced portion. A slider connected to the sliding seat and displacing in the straight line front-back direction is slidably nested with the first and second slider sliding portions. The wire harness wired to the sliding seat is inserted through the slider and into the harness rail and the extra length accommodation case in a front-back direction straight line shape, then the wire harness curves at the front end arced portion of the extra length accommodation case and turns backward.

In the wire harness routing device according to the present invention, the harness rail is installed along the lateral surface of the seat rail, the extra length accommodation case is located so as to be linked to the front end of the harness rail, and the sliding portion of the slider which is linked to front-back displacement of the sliding seat is linked not only to the harness rail but also to the extra length accommodation case. Thus, the slider sliding portion extending in the straight line front-back direction is lengthened, a displacement range of the slider is lengthened, and a total front-back length of the seat rail and the extra length accommodation case is shortened. As a result, the extra length accommodation case is configured to not be located further forward than the seat rail, which a passenger is likely to step on. Thereby, even when preexisting piping and components are located forward of the sliding seat, they do not interfere with the extra length accommodation case.

An opening in a top surface of the first and second slider sliding portions of the harness rail and the extra length accommodation case, respectively, is exposed between tufts that cover terminal edges of openings in carpet laminate material serving as a flooring material of a vehicle interior. The harness rail and the extra length accommodation case are located beneath the flooring material. A space is provided between the carpet laminate material and a floor panel configured with metal plating on a lowermost surface of the vehicle. The space is filled with vibration absorbing material, thermal insulation material, sound insulation material, and the like, absorbing vibration, noise, and heat transmitted to the vehicle interior and maintaining a pleasant environment within the vehicle interior. The seat rail is laid and fixated on a top surface of a support material installed on a top surface of the floor panel, while a recessed portion where the wheels of the sliding seat are slidably nested is exposed in an opening provided in the tufts.

Preferably, the front end of the extra length accommodation case does not protrude further than the front end of the seat rail and the extra length accommodation case has one of the following configurations: a “U” shape with the front end arced portion, forming an overall “J” shape when combined with the harness rail, and extraction is performed through an opening provided on a back end; and substantially an elliptical shape with a front end arced portion and a back end arced portion in which the wire harness is turned backward on the front end side, then is turned again on the back end side to be extracted through an opening provided toward the front.

As noted above, when the extra length accommodation case has an elliptical shape and the wire harness makes one circuit by turning at both the front end side and the back end side, an amount of extra length accommodated can be increased and front-back length of the extra length accommodation case can be shortened.

Preferably, the first slider sliding portion provided to the harness rail and the second slider sliding portion provided to the extra length accommodation case have an opening on the top surface thereof, the extra length accommodation case is positioned with a vertical orientation, the front end arced portion is curved in the vertical direction, and the backward-turning path is located below the second slider sliding portion. As noted above, when the extra length accommodation case is positioned with a vertical orientation, a horizontal area occupied by the extra length accommodation case can be reduced, the extra length accommodation case becomes less likely to be stepped on, there is no need to increase the strength of the extra length accommodation case, and manufacturing costs can be reduced.

Preferably, the first slider sliding portion is provided projecting upward so as to be continuous with a wire harness insertion portion of the harness rail, the slider projects through the opening in the top surface thereof, and the slider connects to a seat foot of the sliding seat. In addition, a caterpillar-type protector preferably sheathes the wire harness inserted through the wire harness insertion portion within the harness rail and the extra length accommodation case. The protector is preferably bent into a tubular shape, the protector being bent along a plurality of bending lines provided at intervals in a width direction and extending in a length direction on a belt-shaped flat plate. In addition, the protector is preferably connected in a state where incisions are made in the width direction at intervals in the length direction such that one side is continuous and other sides are separated, and one side of the incision is curved while a second side is not curved.

The harness rail and the extra length accommodation case may be formed as separate members, or may be integrally formed. When the harness rail and the extra length accommodation case are integrally molded with a resin, cost can be reduced by cutting down on a number of components, and the work of attaching the components to the vehicle can be made less troublesome. Meanwhile, when the harness rail and the extra length accommodation case are separate members, a molding resin of the harness rail can have a higher rigidity than the molding resin of the extra length accommodation case, and resin materials appropriate to an end use can be used to form the components. In addition, an installation position of the harness rail is fixed at a position along the lateral surface of the seat rail, while the extra length accommodation case preferably has a vertical orientation, as noted above. However, the extra length accommodation case can be installed in a horizontal orientation, an inclined orientation, and any desired orientation according to an installation location.

A main body of the caterpillar-type protector having a squared tubular shape or the like has incisions made at intervals in the length direction, and as noted above one side of the incision is curved while the second side is not curved. The squared tubular caterpillar-type protector preferably includes, at intervals, four bending lines at a mid-portion in the width direction, the bending lines extending in the length direction on the strip-shaped flat plate. The caterpillar-type protector also preferably includes an engagement projection projecting on one of two lateral edges in the width direction and an engagement hole on the second lateral edge into which the engagement projection is inserted and engaged. The caterpillar-type protector preferably holds the squared tubular shape by bending along the bending lines into the squared tubular shape and by inserting and engaging the engagement projection with the engagement hole. Moreover, width-direction incision lines linking the four bending lines are preferably provided at intervals in the length direction in a shape separating and bendably connecting three sides of the squared tube.

As noted above, in the wire harness routing device for the sliding seat according to the present invention, the harness rail is installed along the lateral surface of the seat rail, the extra length accommodation case is positioned so as to be linked to the front end of the harness rail, the first and second slider sliding portions are respectively linked to the harness rail and the extra length accommodation case, and the slider linked to the displacement of the sliding seat is made to slide not only on the first slider sliding portion of the harness rail, but also on the second slider sliding portion of the extra length accommodation case. Thus, the total front-back length of the harness rail and the extra length accommodation case is shortened. In this way, because the extra length accommodation case does not protrude further forward than the front end of the seat rail, a concern that the extra length accommodation case will be stepped on can be alleviated, and interference with preexisting components forward of the sliding seat can be prevented. In addition, the second slider sliding portion of the extra length accommodation case is linked to the front end of the first slider sliding portion of the harness rail; therefore, the wire harness can be smoothly drawn into the extra length accommodation case from the harness rail while maintaining a straight line shape.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic perspective view illustrating a sliding seat according to a first embodiment;

FIG. 2A is a schematic front view illustrating a harness rail and an extra length accommodation case according to the first embodiment;

FIG. 2B is a comparative example;

FIG. 3A is a cross-sectional view along a line A-A in FIG. 2A;

FIG. 3B is a cross-sectional view along a line B-B in FIG. 2A;

FIG. 4 is a perspective view of a main portion of the first embodiment;

FIG. 5A is a vertical cross-sectional view of the extra length accommodation case;

FIG. 5B is a cross-sectional view along a line B-B in FIG. 5A;

FIGS. 6A to 6C illustrate a slider used in the first embodiment, where FIG. 6A is a perspective view of the slider, FIG. 6B is a perspective view of a state in which the slider is connected to a wire harness sheathed in a caterpillar-type protector, and FIG. 6C is a perspective view of a state in which the slider connected to the wire harness is joined to the harness rail;

FIGS. 7A and 7B illustrate the caterpillar-type protector, where FIG. 7A is a perspective view and FIG. 7B is an enlarged development view;

FIGS. 8A and 8B are schematic explanatory views illustrating modified examples; and

FIG. 9 illustrates a conventional example.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

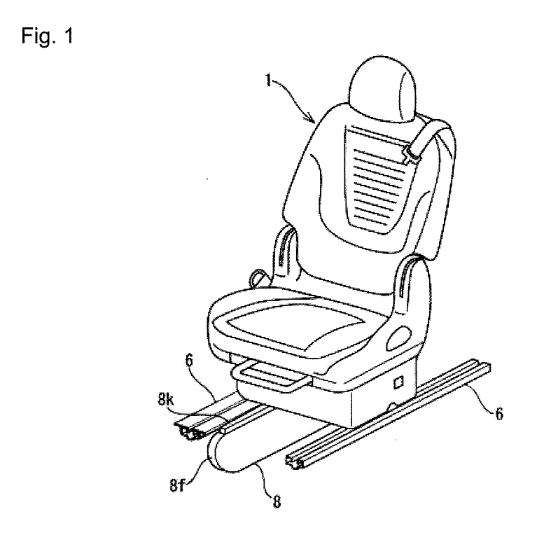

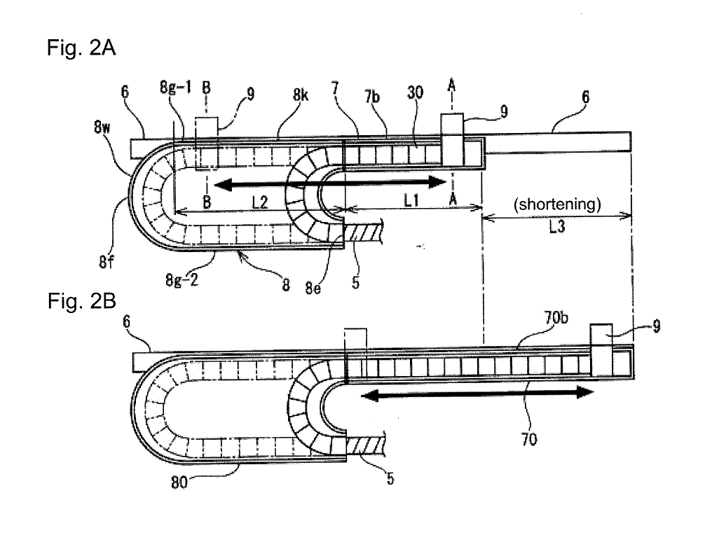

Hereafter, an embodiment of the present invention is described with reference to the drawings. FIGS. 1 through 7 illustrate a first embodiment of the present invention. In order to supply electricity to electrical components (not shown in the drawings) installed in a passenger-side sliding seat 1 mounted in an automobile, as shown in FIG. 1, a wire harness 5 (hereafter referred to as a seat harness 5) is wired to the sliding seat 1 from a floor panel side, as shown in FIGS. 2A and 2B.

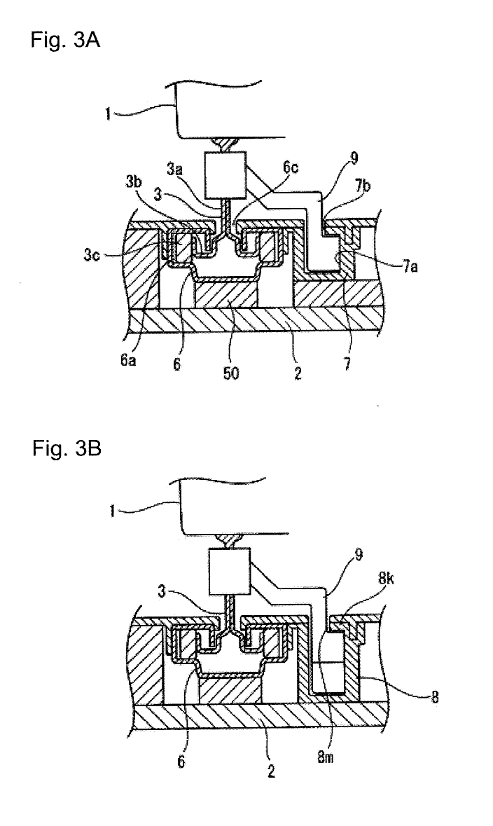

As shown in FIGS. 3A and 3B, a left-right pair of seat feet 3 are provided to a bottom surface of the sliding seat 1. Each seat foot 3 is respectively attached to one of a left-right pair of seat rails 6 in a slidable manner, the seat rails 6 being mounted on top of a floor panel 2 via a support stand 50. For each seat rail 6, a shaft 3a of the seat foot 3 projecting below a seating surface of the sliding seat 1 is inserted within the seat rail 6; arms 3b extend to the left and right from the shaft 3a; and a wheel 3c axially supported on an outer surface of the arm 3b is rotatably fitted inside a lateral space 6a within the seat rail 6.

One harness rail 7 having a straight line shape is installed on a lateral surface of one of the seat rails 6, the harness rail 7 being installed from substantially an intermediate position in a front-back direction toward a back end of the seat rail 6. In addition, an extra length accommodation case 8 is installed on a front end of the harness rail 7. As shown in FIGS. 2A and 2B, a front end 8f of the extra length accommodation case 8 does not protrude further forward than a front end of the seat rail 6.

The seat harness 5 is connected via a connector to a branch line branching from a floor harness routed in the floor panel 2 and is wired into the extra length accommodation case 8 and then into the harness rail 7. The seat harness 5 passed through the harness rail 7 is passed through a slider 9 slidably fitted inside the harness rail 7, the slider 9 is connected to the foot 3 of the sliding seat 1, and the seat harness 5 is connected via a connector to electric wires wired within the sliding seat 1.

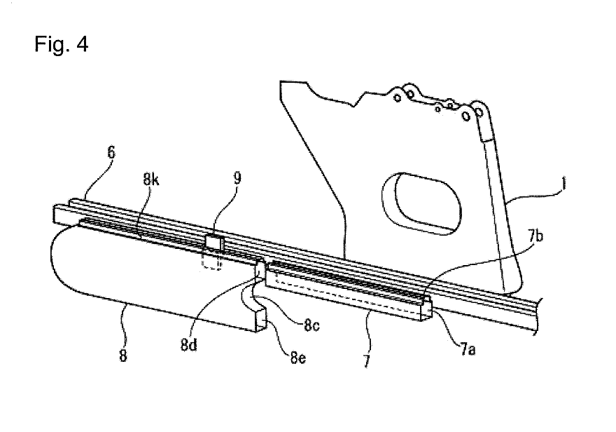

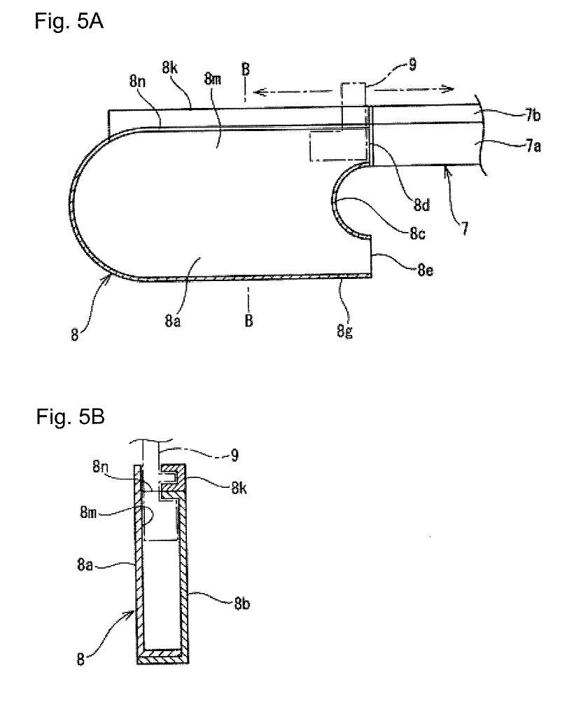

The harness rail 7 and the extra length accommodation case 8 have shapes as shown in FIGS. 4, 5A, and 5B, and are configured with molded resin articles. The harness rail 7 extends in a straight line shape and terminates further forward than a back end of the seat rail 6. The “U”-shaped extra length accommodation case 8 continues from the front end of the harness rail 7 such that an entire assembly of the harness rail 7 and the extra length accommodation case 8 forms substantially a “J” shape.

After the seat harness 5 wired into the sliding seat 1 has been passed through the slider 9 and inserted into the harness rail 7, the seat harness 5 is inserted in a straight line shape from the harness rail 7 into the extra length accommodation case 8, then curves at the front end of the extra length accommodation case 8 and makes a U-turn towards the back. In other words, after being inserted in an overall “J” shape from the harness rail 7 to the extra length accommodation case 8, the seat harness 5 is drawn outward from an opening 8e provided on the back end of the extra length accommodation case 8. As noted above, the harness rail 7 and the extra length accommodation case 8 are formed as separate members and one lateral portion of the back end of the extra length accommodation case 8 is connected to the front end of the harness rail 7. However, the harness rail 7 and the extra length accommodation case 8 may also be integrally molded.

As shown in FIG. 3A, the harness rail 7 includes a harness insertion portion 7a and a first slider sliding portion 7b. The harness insertion portion 7a has a box shape in cross-section and extends along an outer surface of a lateral wall of the seat rail 6. The first slider sliding portion 7b projects on one side of a top surface of the harness insertion portion 7a in a manner continuous with an opening.

The extra length accommodation case 8, which links to the front end of the harness insertion portion 7a of the harness rail 7, has substantially a “U” shape that includes an arced portion 8w on a front end thereof, and is configured with a main body 8a having a comparatively shallow base and a lid 8b covering the main body 8a after the wire harness has been accommodated. A sealed center portion 8c indented in an arced shape is provided at a center of the back end surface of the extra length accommodation case 8, and openings 8d and 8e are provided on two opposing sides of the sealed center portion 8c. One of the openings, 8d, links to a front end opening of the harness insertion portion 7a of the harness rail 7, while the seat harness 5 is extracted through the second of the openings, 8e.

Within the extra length accommodation case 8, between the two sides of the sealed center portion 8c and an inner surface of an outer circumferential wall 8g of the case, the seat harness 5 entering and exiting through the two openings 8d and 8e has a path that is regulated to a direction having a straight line shape. The seat harness 5 is thus guided so as to follow an inner circumferential surface of the case. Guided in this way, the seat harness 5 is made to U-turn at the front end of the extra length accommodation case 8. The seat harness 5, diverted from the harness rail 7 through the interior of the extra length accommodation case 8 and extracted outward, is thus wired in an overall “J” shape, which includes the harness rail 7.

The extra length accommodation case 8 is positioned in a vertical orientation, as shown in FIGS. 1, 2A, 2B, and 4. One straight-line-shaped outer circumferential wall 8g-1 of the main body 8a is designated a top side and a second outer circumferential wall 8g-2 is designated a bottom side. A second slider sliding portion 8k is linked to the front end of the first slider sliding portion 7b of the harness rail 7 and is provided projecting on a top surface of the outer circumferential wall 8g-1 (located on the top side), the second slider sliding portion 8k projecting in a straight-line-shaped region reaching the arced portion 8w on the front end side. The second slider sliding portion 8k is a top surface opening. In addition, the bottom surface creates an opening in the outer circumferential wall 8g-1, along which bottom surface opening 8n a harness insertion path 8m having a straight line shape in a front-back direction along the top outer circumferential wall 8g-1 is formed within the extra length accommodation case 8. The harness insertion path surface 8m links to a harness insertion path 7a of the harness rail 7 in a straight line shape in the front-back direction.

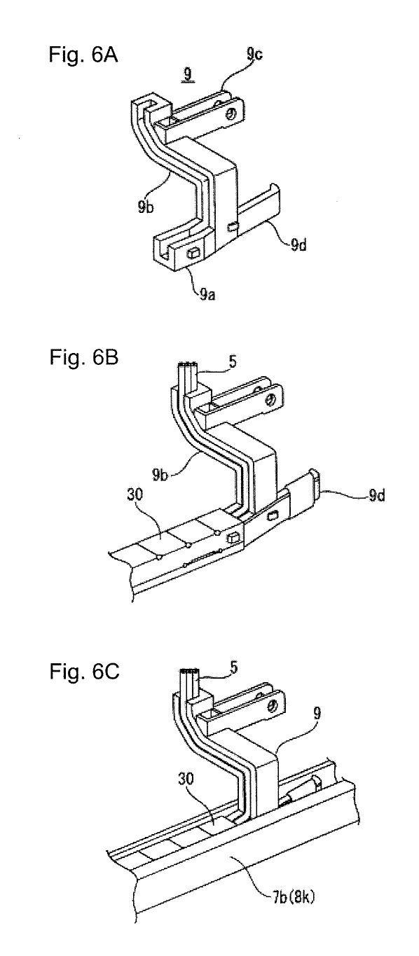

The slider 9 slidably fitted in the slider sliding portion 7b of the harness rail 7 has a shape as shown in FIG. 6A, and protrudes from the first slider sliding portion 7b of the harness rail 7 and the top surface opening of the second slider sliding portion 8k of the extra length accommodation case 8 in a manner inclined toward the sliding seat 1.

The slider 9 is configured with a molded resin article and has a shape shown in FIGS. 6A to 6C. Specifically, the slider 9 is configured with a nesting portion 9a, a guide portion 9b, a vehicle fixating portion 9c, and a protector fixating portion 9d. The nesting portion 9a fits slidably within the first and second slider sliding portions 7b and 8k. The guide portion 9b projects upward from a top end of the nesting portion 9a, then inclines toward the sliding seat 1, then projects upward once again. The vehicle fixating portion 9c projects from a mid-portion of the guide portion 9b. The protector fixating portion 9d fixates to a seat harness sheathing member (a protector 30). The nesting portion 9a and the guide portion 9b have a tubular shape with a lateral surface opening in order to insert the seat harness 5 into an interior thereof. The seat harness 5, which is sheathed by the caterpillar-type protector 30, is extracted from the protector 30 and inserted through the nesting portion 9a toward the guide portion 9b. In addition, a forefront end portion of the protector 30 is fitted around an exterior of the nesting portion 9a, and an attachment tab protruding further than the forefront end of the protector 30 is fixated by tape-winding to the protector fixating portion 9d. In addition, the vehicle fixating portion 9c is tightly fastened to the foot 3 of the sliding seat 1 with a bolt. The slider 9, which is connected to the seat foot 3, can thus be displaced forward and backward accompanying displacement of the sliding seat 1.

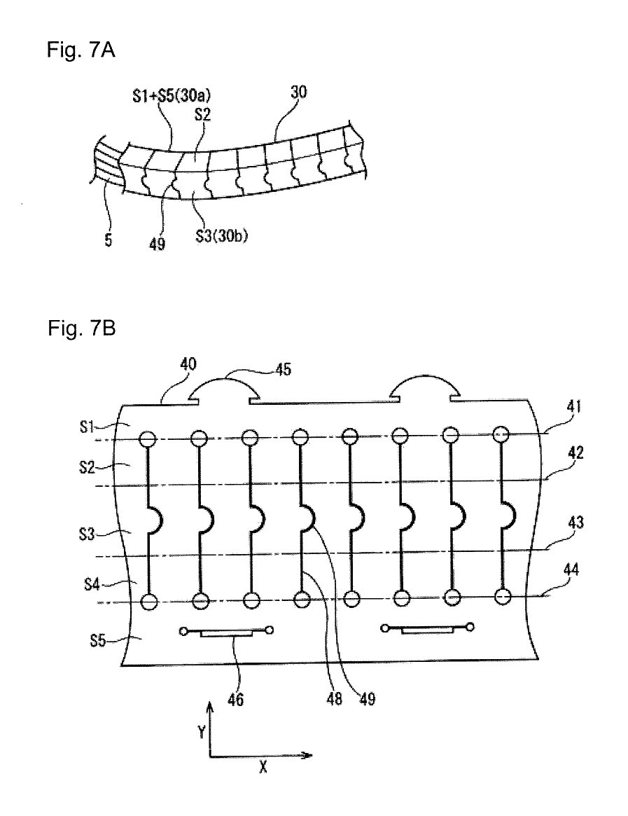

The squared tubular caterpillar-type protector 30 sheathes the seat harness 5, which is slidably wired to the extra length accommodation case 8 and the harness rail 7. The protector 30 is assembled by folding and bending a flat plate 40, which is configured with continuous, strip-shaped long members as shown in FIG. 7B. The flat plate 40 includes four bending lines 41, 42, 43, and 44 at intervals at mid-portions in a width direction Y, the four bending lines 41, 42, 43, and 44 extending in a length direction X. The width direction of the flat plate 40 is subdivided into five sides S1 to S5. The flat plate 40 is configured to be assembled in a squared tubular shape, as shown in FIG. 7A, by bending the bending lines 41 to 44 at right angles and overlapping sides S1 and S5 at the two ends of the width direction. In addition, engagement projections 45 are provided to a lateral edge of the side S1 at intervals in the length direction X, the side S1 being on one of the two width-direction sides of the flat plate 40. Long, thin engagement holes 46, into which the engagement projections 45 are inserted and engaged, are provided on the side S5, which is on the second side of the flat plate 40.

The flat plate 40 includes width direction Y incision lines 48 at intervals in the length direction X, the incision lines 48 linking the four bending lines 41 through 44. The sides S2, S3, and S4 are thus separated. In addition, an arced incision 49 is provided at a center position of the side S3, the arced incision 49 causing a straight line in a center portion of the incision line 48 to curve. The arced incision 49 causes one side adjacent in the length direction to protrude in an arced shape and a second side to recess in the arced shape, providing nesting protruding and recessed portions.

Although the protector 30 is folded and bent in advance at the bending lines 41 to 44, a group of wires in the wire harness 3 is inserted when the protector 30 is in an open state where the engagement projections 45 are not inserted into the engagement holes 46. The group of wires are inserted through an opening between the two sides S1 and S5 of the bent protector 30. After inserting the group of wires, S1 and S5 are overlapped, the engagement projections 45 are inserted into and engaged with the engagement holes 46, and the group of wires is sheathed in a state where the group of wires is inserted inside the squared tube.

The protector 30 is configured such that the three sides S2, S3, and S4 of the squared tube are separated in the length direction by the incision line 48, and such that the overlapped and engaged sides S1 and S5 are connected in the length direction. In addition, the separated side S3 and the adjacent side S3 are fitted together by the recess and protrusion at the arced incision 49. Specifically, short squared tubes are sequentially linked in a manner freely curving on the separated side S3 side and adjacent squared tubes are fitted together by the recess and protrusion. Therefore, the caterpillar-shaped protector 30 does not become misaligned in the width direction.

The seat harness 5 extracted through the slider 9, the interior of the harness insertion portion 7a of the harness rail 7, and the extra length accommodation case 8 toward the vehicle body slides while curving. The caterpillar-type protector 30 is curvable in a manner similar to a conventionally used corrugated tube, and thus can be favorably used as a sheathing member for the seat harness 5.

In addition, when the caterpillar-type protector 30 is used, the protector 30 can also be nested with the cross-sectionally box-shaped harness insertion portion 7a of the harness rail 7 in a manner sliding freely without jostling. Moreover, both lateral surfaces of the protector 30 slide in a manner sliding freely between the lid 8b and the main body 8a of the extra length accommodation case 8, and can be displaced in a stable orientation.

Next, movement of the seat harness 5 accompanying the front-back displacement of the sliding seat 1 is described. In conjunction with displacement of the sliding seat 1 in the front-back direction, the slider 9 nested with the first slider sliding portion 7b of the harness rail 7 displaces forward and backward along the top wall of the seat rail 6. The protector 30 sheathing the seat harness 5 inserted through the slider 9 displaces forward and backward within the harness insertion portion 7a of the harness rail 7, and the seat harness 5 exits and enters the extra length accommodation case 8 according to the front-back displacement. Thereby, the seat harness 5 smoothly follows the sliding movement of the sliding seat 1.

Specifically, a solid line in FIG. 2A illustrates a state in which the sliding seat 1 is displaced backward, and a dot-and-dash line illustrates a state in which the sliding seat 1 is displaced forward. During backward displacement, shown by the solid line, the slider 9 is positioned at a back end of the harness rail 7 and the seat harness 5 is drawn out toward the back. When the sliding seat 1 is displaced forward from the backward position, in conjunction therewith the slider 9 advances from the first slider sliding portion 7b of the harness rail 7 and displaces toward the second slider sliding portion 8k of the extra length accommodation case 8, and the length of the seat harness 5 accommodated within the extra length accommodation case 8 is increased.

Specifically, as shown in FIG. 2A, a dimension of front-back displacement of the slider 9 accompanying the front-back displacement of the sliding seat 1 is a total length of a length L1 and a length L2, the length L1 being the length of the first slider sliding portion 7b of the harness rail 7 and the length L2 being the length of the second slider sliding portion 8k, which has a length substantially corresponding to the length of the extra length accommodation case 8. Thus, as shown in FIG. 2B, a length L3 of a harness rail can be shortened as compared with a case where a slider sliding portion 70b is provided only to a harness rail 70 and a slider sliding portion is not provided to an extra length accommodation case 80. Accordingly, in FIG. 2B, the harness rail 70 was extended to the back end of the seat rail 6. In contrast, as shown in FIG. 2A, the harness rail 7 can terminate further forward than the back end of the seat rail 6.

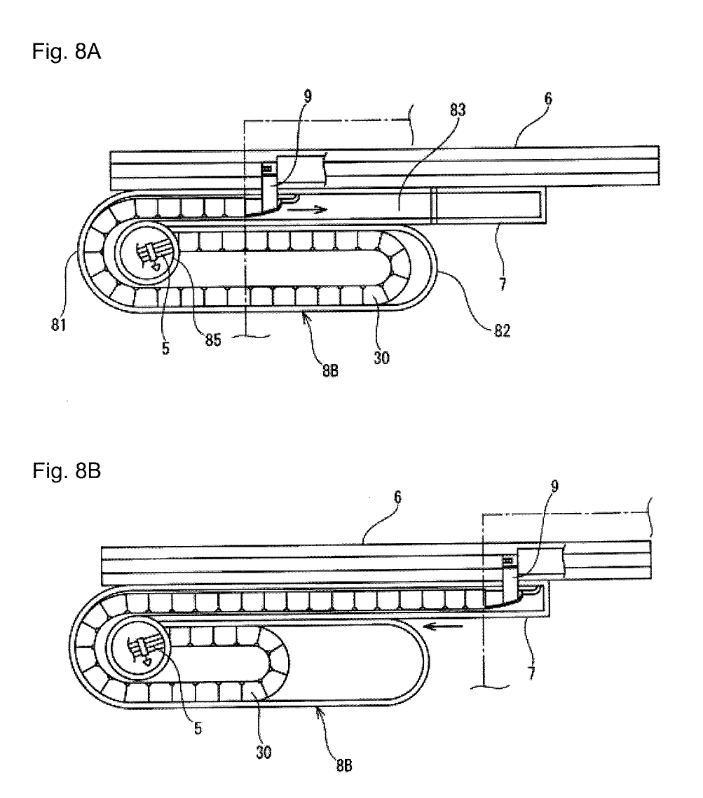

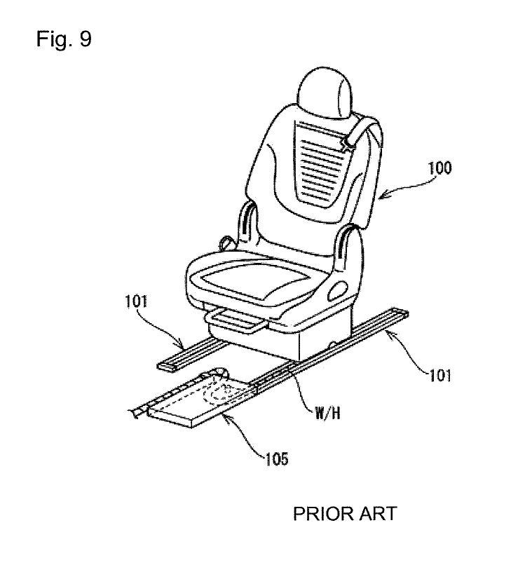

FIGS. 8A and 8B illustrate modified examples of an extra length accommodation case. An extra length accommodation case 8B is an elliptical portion that links, on a back end thereof, a straight line insertion portion 83 to the front end of an arced portion harness rail 7. The extra length accommodation case 8B includes a front end curved portion 81 on a front end of the straight line insertion portion and also includes a back end curved portion 82. Thereby, within the extra length accommodation case 8B, the seat harness 5 moves forward→curves→moves backward→curves→moves forward, and is then extracted outward from a wire harness extraction opening 85 provided to a forward portion. Similar to the above-noted embodiment, a second slider sliding portion is provided to the straight line insertion portion 83 linked to the harness rail. With the above-described configuration, a dimension of the wire harness accommodated within the extra length accommodation case 8B is made large and an amount of extra length accommodated is increased. Other configurations are similar to those of the above-noted embodiment and descriptions thereof are omitted.

The wire harness routing device for the sliding seat according to the present invention is not limited to the above-noted embodiment. Various modifications are possible without departing from the scope of the present invention.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A wire harness routing device for a sliding seat comprising:
a harness rail having a straight line shape, the harness rail extending in a front-back direction adjacent to a lateral surface of a seat rail of a sliding seat mounted in a vehicle; and
an extra length accommodation case linked to a front end of the harness rail,
wherein the harness rail is provided with a first slider sliding portion extending in the front-back direction, the extra length accommodation case is provided with a second slider sliding portion linked to a front end of the first slider sliding portion and extending in a straight line front-back direction until reaching a front end arced portion,
a slider connected to the sliding seat and displaceable in the straight line front-back direction is slidably nested with the first and second slider sliding portions, and
a wire harness wired to the sliding seat is inserted through the slider and into the harness rail and the extra length accommodation case in a front-back direction straight line shape, then the wire harness curves at the front end arced portion of the extra length accommodation case and turns backward.

2. The wire harness routing device for a sliding seat according to claim 1, wherein
the front end of the extra length accommodation case does not protrude further than the front end of the seat rail, and
the extra length accommodation case is configured in a “U” shape with the front end arced portion, and forms an overall “J” shape in combination with the harness rail, and extraction is performed through an opening provided on a back end.

3. The wire harness routing device for a sliding seat according to claim 1, wherein
the front end of the extra length accommodation case does not protrude further than the front end of the seat rail, and
the extra length accommodation case is configured in a substantially elliptical shape with a front end arced portion and a back end arced portion in which the wire harness is turned backward on the front end side, then is turned again on the back end side to be extracted through an opening provided toward the front.

4. The wire harness routing device for a sliding seat according to claim 1, wherein
the first slider sliding portion of the harness rail and the second slider sliding portion of the extra length accommodation case both have an opening on the top surfaces thereof, and
the extra length accommodation case is positioned with a vertical orientation, the front end arced portion is curved in the vertical direction, and the backward-turning path is located below the second slider sliding portion.

5. The wire harness routing device for a sliding seat according to claim 4, wherein
the first slider sliding portion projects upward so as to be continuous with a wire harness insertion portion of the harness rail, the slider projects through the opening in the top surface thereof, and the slider connects to a seat foot of the sliding seat, and
a caterpillar-type protector sheathes the wire harness inserted through the wire harness insertion portion within the harness rail and the extra length accommodation case.

6. The wire harness routing device for a sliding seat according to claim 5, wherein
the protector is bent into a tubular shape by bending along a plurality of bending lines provided at intervals in a width direction and extending in a length direction on a belt-shaped flat plate, the protector is connected in a state where incisions are made in the width direction at intervals in the length direction such that one side is continuous and other sides are separated, and one side of the incision is curved while a second side is not curved.
